(19) United States
(12) Patent Application Publication
(10) Pub. No.: US 2010/0237778 A1
(43) Pub. Date: Sep. 23, 2010

(54) Bushing system for a lamp

(75) Inventors: Stephan Berndanner, Yokohama (JP); Gerhard Löffler, Eichstatt (DE); Jürgen Meier, Weissenburg (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM Gesellshaft, Munchen (DE)

(21) Appl. No.: 12/308,584

(22) PCT Filed: Jul. 5, 2007
(86) PCT No.: PCT/EP2007/056791

§ 371 Date: Dec. 18, 2008

(30) Foreign Application Priority Data
Jul. 14, 2006 (DE) 10 2006 032 752.7

(51) Int. Cl. H01J 61/06; H01J 9/02

(52) U.S. Cl. 313/613; 445/26

(57) ABSTRACT

Disclosed is a bushing system for a lamp, comprising at least one electrode and/or lead-in wire that is/are embedded in a final section of a lamp vessel by means of a glass seal. At least some sections of said electrode and/or lead-in wire are provided with an antioxidant layer in the zone of the glass seal. Also disclosed are a lamp comprising such a bushing system as well as a method for the production thereof.

### TECHNICAL FIELD

The invention relates to a bushing system for a lamp comprising at least one electrode and/or lead-in wire that is/are embedded in an end section of a lamp vessel of the lamp by means of a glass seal, at least some sections of said electrode and/or lead-in wire being provided with a layer of oxidation inhibitor in the area of the glass seal. Also disclosed are a lamp having such a bushing system as well as a method for the production thereof.

### PRIOR ART

Bushing systems of this kind are used, for example, for electrical bushings in quartz or hard glass rod fusion joints of high-pressure discharge lamps or lead-in wires for halogen lamps and the like. In principle, however, the bushing system according to the invention can be used for a multitude of different lamp types.

A high-pressure discharge lamp with a bushing system of this kind is described, for example, on the Internet domain www.osram.de under the product name “XBO®”. These high-pressure discharge lamps have a discharge vessel made from quartz glass with two diametrically arranged sealed bulb skirts, the free end sections of which are each provided with a base sleeve. Two diametrically arranged tungsten electrodes, between which a gas discharge is formed when the lamp is operating, extend into the interior of the discharge vessel. A glass sleeve made from an intermediate sealing glass, which is enlarged by further intermediate sealing glass in the direction of the base and led back to the bulb skirts, is fused onto the tungsten rod in each case in order to retain the electrodes in the discharge vessel (dome fusing).

A supporting roll made of quartz glass, which can be slid in the longitudinal direction and which is pre-stressed against an approximately conical valve seat of the bulb vessel by means of a compression spring supported on the glass sleeve fused onto the electrode rod, is fitted in each of the bulb skirts to further support the electrodes. As the electrodes tend to form tungsten oxides due to the high operating temperatures of the lamp, wherein the oxides initially form on the outer regions of the electrodes and then advance under the glass seal, i.e. under the glass sleeve, the transitions from metal to glass must be protected against through-oxidation. Because of this temperature-dependent formation of oxide, the volume of said components increases and causes an additional increase in stress in the glass seal, which can lead to breakage and therefore to premature failure of the lamp. According to the prior art, a thin glass tube is fused onto the electrode before sealing which prevents oxygen from the air penetrating into the seal area and thus acts as an oxidation inhibitor.

The disadvantage with this type of bushing system is that, due to the sealing technology, extensive production effort is required to fit the thin glass tubes onto the electrodes. Although this method is very reliable with regard to inhibiting oxidation, this function is only achieved with very high quality standards.

### SUMMARY OF THE INVENTION

The invention is based on the object of creating a bushing system for a lamp and a lamp fitted with a bushing system of this kind as well as a method for producing a lamp of this kind, with which a formation of oxide in the region of the glass seal of the electrodes or bushings is prevented with a minimum of production effort compared with conventional solutions.

According to the invention, this object is achieved by a bushing system for a lamp comprising at least one electrode and/or lead-in wire that is/are embedded in an end section of a lamp vessel of the lamp by means of a glass seal, at least some sections of said electrode and/or lead-in wire being provided with a layer of oxidation inhibitor in the area of the glass seal. As a result of the layer of oxidation inhibitor applied to at least some sections of the electrode and/or lead-in wire in the area of the glass seal, oxide formation in the area of the glass seal and therefore a failure of the lamp is effectively prevented. In contrast with the prior art, this enables the laborious fitting of thin glass tubes onto the electrodes to be dispensed with.

The object is further achieved by a lamp having at least one bushing system of this kind.

Furthermore, this object is achieved by a method for producing a lamp with which, in a first step, at least one electrode and/or one lead-in wire is placed in a lamp vessel and sealed with glass, and subsequently a layer of oxidation inhibitor is applied to the electrode and/or lead-in wire, so that this runs beneath at least some sections of the area of the glass seal.

According to a particularly preferred exemplary embodiment of the invention, the layer of oxidation inhibitor comprises a solder, preferably a hard solder with a copper, silver or brass base. In this case, the transition from tungsten to the glass seal is permanently protected against oxidation at operating temperature by a coating of hard solder.

It has been shown to be particularly advantageous when the solder forms an alloy with the electrode and/or the lead-in wire, thus enabling a high-strength mechanical and thermal bonding of the layer of oxidation inhibitor.

Preferably, the layer of oxidation inhibitor extends over a length of up to 5 mm under the area of the glass seal of the electrode and/or lead-in wire.

In an exemplary embodiment according to the invention, the layer of oxidation inhibitor is arranged on at least some sections of an outer peripheral surface of the electrode and/or lead-in wire.

In an exemplary embodiment according to the invention, the electrodes and/or lead-in wires are made of tungsten.

In a preferred method for producing a bushing system, the layer of oxidation inhibitor is applied to the electrode and/or lead-in wire by means of a soldering method, preferably a hard soldering method, so that the solder forms an alloy with the electrode and/or lead-in wire. As a result of the layer of oxidation inhibitor applied in the area of the glass seal, oxide formation in the area of the glass seal and therefore a failure of the lamp is effectively prevented.

### BRIEF DESCRIPTION OF THE DRAWINGS

The invention is described in more detail below with reference to a preferred exemplary embodiment. In the drawing:

FIG. 1 shows a schematic representation of an XBO® high-pressure discharge lamp with a bushing system according to the invention, and

FIG. 2 shows an enlarged representation of the detail Y of the XBO® high-pressure discharge lamp from FIG. 1.

### PREFERRED IMPLEMENTATION OF THE INVENTION

The invention is explained below with reference to an XBO® high-pressure lamp, which is used in projection systems and spotlights for example. As already mentioned in the introduction, however, the bushing system according to the invention is in no way restricted to lamps of this type.

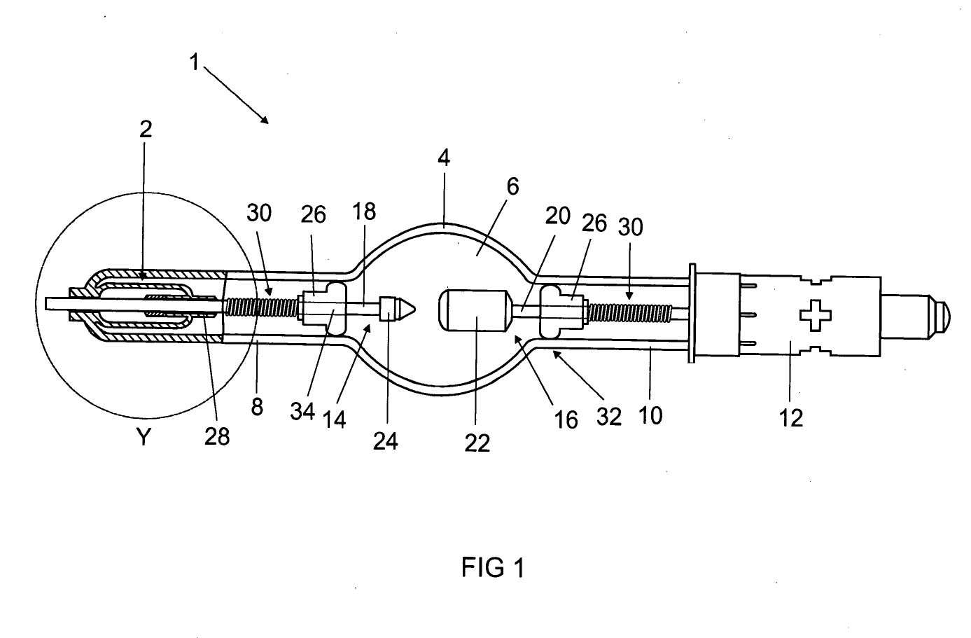

FIG. 1 shows a schematic representation of an XBO® high-pressure discharge lamp 1 having a base at each end, using short-arc technology, and having a bushing system 2 according to the invention. This has a discharge vessel 4 made from quartz glass with an interior 6 and two diametrically arranged sealed bulb skirts 8, 10, the free end sections of which are each provided with a base sleeve 12 (the base sleeve on the left-hand bulb skirt 8 is not shown). Two diametrically arranged electrodes 14, 16, between which a gas discharge is formed when the lamp is operating, extend into the interior 6. An ionizable filling, which consists essentially of high-purity xenon, is enclosed in the interior 6 of the discharge vessel 4. In the exemplary embodiment shown, the electrodes 14, 16 are each designed as a two-piece electrode system comprising a current carrying rod-shaped electrode holder 18, 20 and a discharge-side head electrode 22 (anode) and head electrode 24 (cathode), respectively, which are soldered thereto. According to FIG. 1, the left-hand electrode head 24 is designed as a conical head cathode to generate high-temperatures in order to guarantee a defined onset of the arc and an adequate flow of electrons due to thermal emission and field emission (Richardson equation). The right-hand electrode head 22 in FIG. 1 is designed as a highly thermally stressed barrel-shaped head anode with which the radiation power is improved by adequate dimensioning of the electrode size. In the following, the general term electrode 14, 16 is used for the two-piece electrode system. In order to retain the electrodes 14, 16 in the discharge vessel 4 in the exemplary embodiment shown, a tungsten rod fusion joint with intermediate sealing glass is used on the base side and a valve seat technique on the bulb side, with which supporting rolls 26 in the shape of a truncated cone are fitted in sections of the bulb skirts 8, 10, wherein said rolls are made from quartz glass and are slidable in the longitudinal direction, and are pre-stressed against an approximately conical valve seat 32 of the discharge vessel 4 by means of a compression spring 30, which is supported on a glass sleeve 28 fused onto the electrodes 14, 16, and are provided with an axial through hole 34 for accommodating the electrodes 14, 16. The retaining rods 18, 20 of the electrodes 14, 16 are fed into the through holes 34 in such a way that they extend into the interior 6 where they carry the electrode heads 22 and 24 respectively.

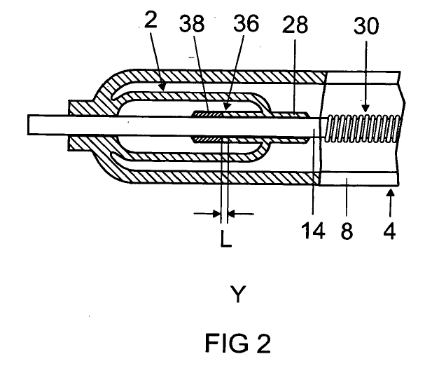

According to FIG. 2, which shows an enlarged representation of the detail Y from FIG. 1, a plurality of intermediate glass seals, which are enlarged and led back towards the base end, are fused onto the glass sleeve 28 (dome fusing). This structure overcomes the different coefficients of expansion of the electrodes 14, 16 and the discharge vessel 4. Leading back by means of sealing glass is necessary, as adequate stability of the discharge lamp 1 can only be achieved when purely compressive stresses and not tensile stresses act on the glass due to the filling gas pressure in the cold state and also in operation of the lamp 1. As the glass sleeve 28 can be blown off due to the oxygen in the air while forming tungsten oxide on the electrodes 14, 16, the electrodes 14, 16 are provided with a layer of oxidation inhibitor 38 in the area of a glass seal 36. As a result of the layer of oxidation inhibitor 38, oxide formation in the area of the glass seal 36 and therefore a failure of the lamp 1 is effectively prevented. In the exemplary embodiment of the invention shown, the layer of oxidation inhibitor 38 consists of a hard solder with a copper base. The hard solder 38 extends from the outside over a length L of about 1 mm under the area of the glass seal 36 of the electrodes 14, 16, and is applied to an outer peripheral surface of the electrodes 14, 16 in such a way that it forms an alloy with the electrodes 14, 16, thus achieving a high-strength mechanical and thermal bonding of the layer of oxidation inhibitor 38.

Finally, the production of the bushing system 2 is explained below with reference to FIGS. 1 and 2 as an example. In a first step, the electrodes 14, 16 are placed and sealed in the discharge vessel 4. The layer of oxidation inhibitor 38 is then applied to the electrodes 14, 16, so that this runs beneath at least some sections of the area of the glass seal 36. The layer of oxidation inhibitor 38 is applied in the form of hard solder by a hard soldering method to the electrodes 14, 16, so that the solder forms an alloy with the electrodes. This alloy layer extends approx. 1 mm under the glass seal 36 and effectively protects said seal against tungsten oxide creeping beneath it.

The bushing system 2 according to the invention is not restricted to the high-pressure discharge lamp 1 described, rather the bushing system 2 can be used for different lamp types, for example halogen lamps.

Disclosed is a bushing system 2 for a lamp 1 comprising at least one electrode 14, 16 and/or lead-in wire that is/are embedded in an end section 8, 10 of a lamp vessel 4 of the lamp 1 by means of a glass seal 36, at least some sections of said electrode 14, 16 and/or lead-in wire being provided with a layer of oxidation inhibitor 38 in the area of the glass seal 36. Also disclosed are a lamp 1 comprising such a bushing system 2 as well as a method for the production thereof.

1. A bushing system for a lamp (1) comprising at least one electrode (14, 16) and/or lead-in wire that is/are embedded in an end section (8, 10) of a lamp vessel (4) of the lamp (1) by means of a glass seal (36), characterized in that at least some sections of said electrode (14, 16) and/or lead-in wire are provided with a layer of oxidation inhibitor (38) in the area of the glass seal (36).

2. The bushing system as claimed in claim 1, wherein the layer of oxidation inhibitor (38) comprises a solder, in particular a hard solder with a copper, silver or brass base.

3. The bushing system as claimed in claim 2, wherein the solder (38) forms an alloy with the electrode (14, 16) and/or the lead-in wire.

4. The bushing system as claimed in claim 1, wherein the layer of oxidation inhibitor (38) is arranged on at least some sections of an outer peripheral surface of the electrode (14, 16) and/or lead-in wire.

5. The bushing system as claimed in claim 1, wherein the layer of oxidation inhibitor (38) extends over a length (L) of up to 5 mm under the area of the glass seal (36) of the electrode (14, 16) and/or lead-in wire.

6. The bushing system as claimed in claim 1, wherein the electrode (14, 16) and/or lead-in wire is made of tungsten.

7. A lamp, in particular a high-pressure discharge lamp, having at least one bushing system (2) as claimed in claim 1.

8. A method for producing a lamp (1) as claimed in claim 7 with the steps:
a) placement and sealing with glass of at least one electrode (14, 16) and/or at least one lead-in wire in a lamp vessel (4);
b) application of the layer of oxidation inhibitor (38) to the electrode (14, 16) and/or lead-in wire, so that this runs beneath at least some sections of the area of the glass seal (36).

9. The method as claimed in claim 8, wherein the layer of oxidation inhibitor (38) is applied to the electrode (14, 16) and/or lead-in wire by means of a soldering method, in particular a hard soldering method, so that the solder forms an alloy with the electrode (14, 16) and/or lead-in wire.
